(19) United States
(12) Patent Application Publication
(10) Pub. No.: US 2013/0045729 A1
(43) Pub. Date: Feb. 21, 2013

(54) LOCATION-BASED PROMOTION OF APPLICATIONS

(71) Applicants: Fadi Haik, Shafaram (IL); Yair E. Gheva, Zichron Yaakov (IL); Elinor Axelrod, Tel Aviv (IL)

(72) Inventors: Fadi Haik, Shafaram (IL); Yair E. Gheva, Zichron Yaakov (IL); Elinor Axelrod, Tel Aviv (IL)

(73) Assignee: Microsoft Corporation, Redmond, WA (US)

(21) Appl. No.: 13/211,322

(22) Filed: Aug. 17, 2011

(51) Int. Cl. H04W 4/02; H04W 24/00

(52) U.S. Cl. 455/418; 455/456.3

(57) ABSTRACT

Architecture that integrates location-based information and application-driven devices (e.g., cell phones). Users can now be provided the most relevant application and/or application data based on the user location. Thus, users are assisted in finding the relevant application(s) to accomplish a task based on their current location. More specifically, given a location (e.g., business) registered to a service, the user's client application is automatically updated to comprise the data relevant to that location. Alternatively, or in combination therewith, the service can suggest installing a new application relevant to the location.

### BACKGROUND

Mobile devices are rapidly becoming the ubiquitous tool by which users perform a wide variety of desired functions in addition to making calls. Calendars, email, alarms, and texting are some examples of the versatility of the device, as well as geolocation services. Thus, the location of these devices can be obtained. Additionally, mobile devices are becoming application driven. However, existing paradigms lack the capability to provide more useful functionality for the users of such devices at least in terms of geolocation capabilities and applications.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture integrates the capabilities of location-based technology and application-driven devices (e.g., cell phones). Users can now be provided the most relevant application and/or application data based on the user location (e.g., geographic). Thus, users can be assisted in finding the relevant applications and data to accomplish a task based on their current location.

In one implementation, a mobile device automatically detects that it has been relocated to a specific location, to which a service has registered (e.g., restaurant, bank, grocery store, etc.). Upon detection, the service can update an existing client-side application with location-relevant information and/or suggest installing a new location-relevant application. An application store list is also updated according to the detected location, and when prompted, the list can be sorted (e.g., by location relevance). More specifically, given a location registered to a service, the mobile device is automatically updated to comprise the relevant information (updates and/or new installs) for a given geographic location.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a system in accordance with location-based promotion of applications.

FIG. 2 illustrates an alternative system that further employs management and a provider for the location-based promotion of applications.

FIG. 3 illustrates an exemplary implementation of a system for location-based application promotion.

FIG. 4 illustrates a method in accordance with the disclosed architecture.

FIG. 5 illustrates further aspects of the method of FIG. 4.

FIG. 6 illustrates an alternative method in accordance with the disclosed architecture.

FIG. 7 illustrates further aspects of the method of FIG. 6.

FIG. 8 illustrates a block diagram of a computing system that executes relevant information promotion in accordance with the disclosed architecture.

### DETAILED DESCRIPTION

The disclosed architecture automatically detects relevant applications and/or application data based on the user's geographic location. Thus, applications and/or data can be associated with (mapped to) a specific location and changed/added-to based on the location.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

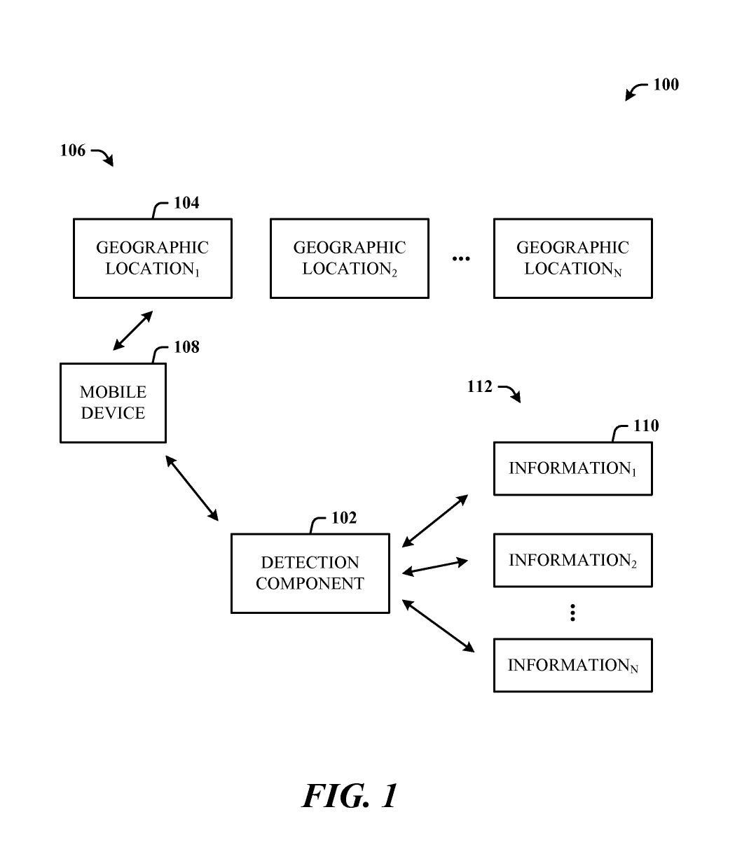

FIG. 1 illustrates a system 100 suitable for execution on a mobile device in accordance with location-based promotion of applications. The system 100 includes a detection component 102 that detects a geographic location 104 (of many locations 106) of a mobile device 108 (and hence, device user) and checks for information 110 (e.g., of a set or store of information 112) such as a location-relevant application in response to detection of the geographic location 104. The information 110 is relevant to the geographic location 104.

For example, if the location 104 includes (e.g., in a strip mall) or is a bank, the information 110 can be an application skin or tile (e.g., application data) that is loaded onto the mobile device 108 and presented for viewing by the device user along with other application skins. The information 110 can be an application install related to the bank, where the install enables the device user to quickly and conveniently access a user account at the bank. The install can also be an advertisement, for example, that plays and presents to the user specials being run by the bank such as for account interest rates, first-time-user account openings, etc.

In other words, the information 110 can include application data related to the geographic location 104. The information 110 can include an application install related to the geographic location 104. Thus, the detection component 102 can further check for application data related to the geographic location and/or the application install. The detection component 102 can automatically install the location-relevant application (with or without user intervention). The location-relevant application can be mapped to the geographic location 104 and accessed when the mobile device 108 reaches the geographic location 104. Detection of the device 108 reaching the location 104 can be accomplished using geolocation technologies such as GPS (global positioning system), triangulation, and geo-fence, for example.

Geo-fence technology enables the definition of a virtual perimeter in association with a location. In radius-based geo-fencing, a fixed radius (e.g., three miles) is defined around the location. When the device location intersects a geographic coordinate associated with the virtual perimeter, a notification is generated and sent to the device user. In polygon-based geo-fence, the perimeter need not be based on a fixed radius, but a virtual polygonal perimeter formed about the location, the intersection of which by the device location then triggers the notification or action to the user or user device.

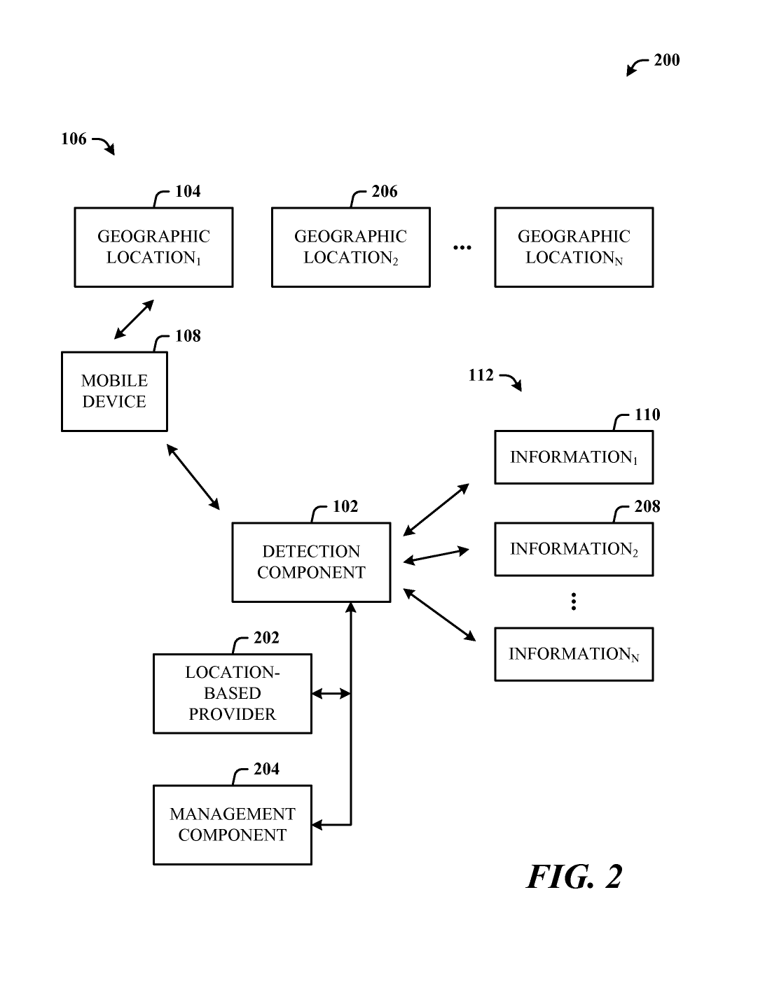

FIG. 2 illustrates an alternative system 200 that further employs management and a provider for the location-based promotion of applications. The system 200 includes a location-based provider 202 that registers services and interfaces to the detection component 102 to provide the information 110 as relevant data and relevant application installs. The location-based provider 202 processes client requests (e.g., of a client of the device 108) for the location-relevant application (e.g., as part of the information 110). The system 200 can further comprise a management component 204 that enables user management of notifications, data, and/or application installs via the detection component 102. In other words, the user can interact with a management interface that enables user setting of parameters related to notifications, notification types, destination of the notification, time to be sent, etc. Management can also include opting in or opting out of receiving notifications, installs, and updates. Other management functions can be provided as desired.

The management component 204 adjusts presentation of an application list based on the geographic location 104. For example, where the information 110 is a skin (or tile) associated with an install or data update, the skin is sorted against other new or existing skins and elevated for viewing (and optionally, selection) by the user of the device 108, via the device 108, when the user is at the location 104.

When the user departs the location 104, and enters a second location 206, the detection component 102 detects this change in location from location 104 to the second location 206, and the system operations repeat such that if new information (e.g., information 208) exists in association with the second location 206, this new information is discovered and the user is notified to either install it, or to reject it. If installed, this new information may include a new application skin that is then sorted and elevated for viewing by the user while at the second location 206. The initial skin installed to the device 108 at the location 104 can then be removed from viewing (e.g., automatically during the sorting process, manually by the user, and/or according to user management settings).

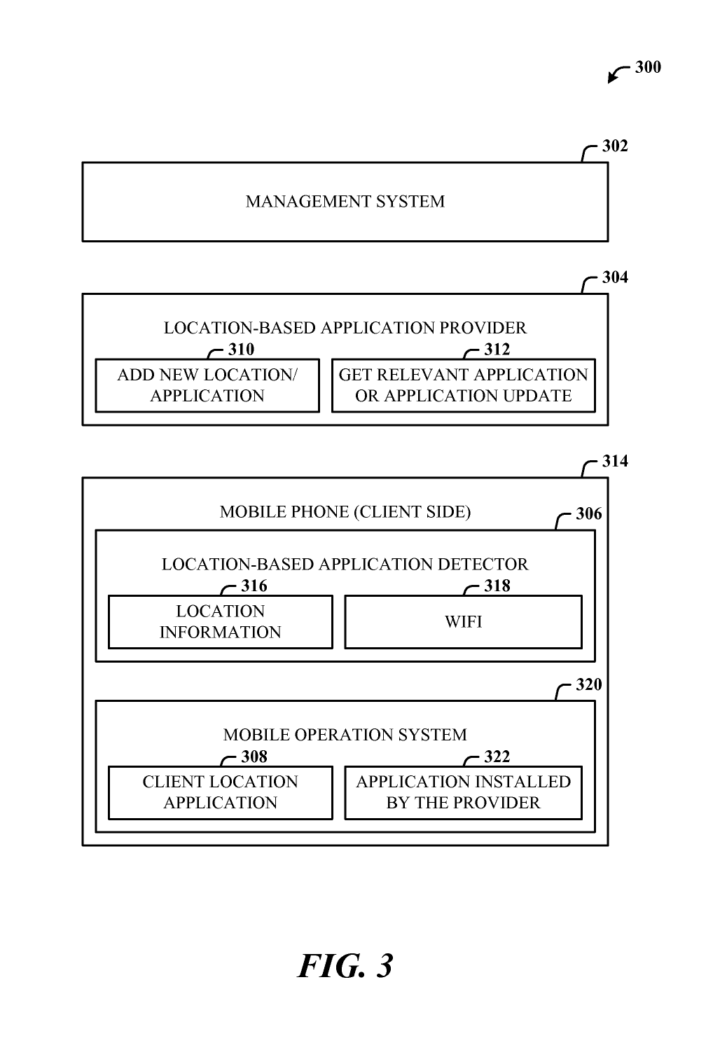

FIG. 3 illustrates an exemplary implementation of a system 300 for location-based application promotion. The system 300 comprises a management system 302 (the management component 204), a location-based application provider 304 (the location-based provider 202), location-based application detector 306 (the detection component 102), and a client application 308.

The management system 302 enables the user to configure the location-based application detector 306, and wrapping of the application store, by sorting the applications based on the new location to display a relevant applications list, based on the location. The client system is configurable. The user can disable notifications regarding the relevant application and disable updating of an existing application. The user can set the notification type when a new application is detected (e.g., sound, small icon, animation, etc.).

The location-based application provider 304 handles location-based application requests from the device client. The client application interacts with the provider 304. The location-based application provider 304 provides an application and/or the data for updating the existing application, relevant to the user location. The provider 304 can receive subscriber requests from vendors (e.g., businesses) to register vendor service(s). Thus, the provider 304 can add a new location (e.g., new business) and any associated new relevant application and/or new application data, etc., as indicated at 310, and get relevant application and/or application updates, as indicated at 312. When the user approaches a location (e.g., a geographic location known to the provider), the client-side application contacts the application provider 304 and requests the relevant information (e.g., update).

The location-based application provider 304 may be implemented as a centralized server that serves several location-based applications and/or application data, as a local website which the client can access to download or update an application (e.g., a WiFi connection can be employed using this website), and/or the client application is updated periodically storing predefined applications and matching locations for efficiency.

As part of a mobile phone 314 (e.g., the mobile device 108), the location-based application detector 306 automatically detects the user location and checks whether there is any registered application for that location and/or an update for the client's existing application. The detector 306 is shown as including location information 316 and communications capability via WiFi technology 318. The mobile phone 314 includes a mobile operation system 320, which further comprises the client location application 308 (e.g., GPS, geo-fence, etc.) and an application 322 installed by the provider 304.

When it is determined (by the detector 306) that the user has approached a new location, the detector 306 checks if the current location is associated with (or mapped to) a relevant application and/or updates for the existing applications. If there is a relevant application, the user receives a notification suggesting that the user install the application, as well as providing an explanation for the added value of the application install.

The client application interacts with the location-based provider 304 and receives updates, either to the phone 314 with new application installs, or with new skins (tiles) for the applications, for example.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

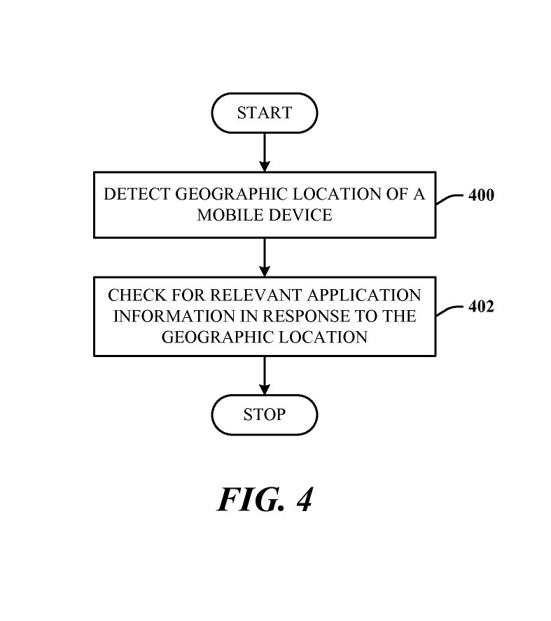

FIG. 4 illustrates a method suitable for execution on a mobile device in accordance with the disclosed architecture. At 400, geographic location of the mobile device is detected. At 402, a check is performed for relevant application information in response to the geographic location. In other words, once the user device is detected to be at or some distance from the geographic location, the check is automatically performed for availability (e.g., existence) of the relevant application information.

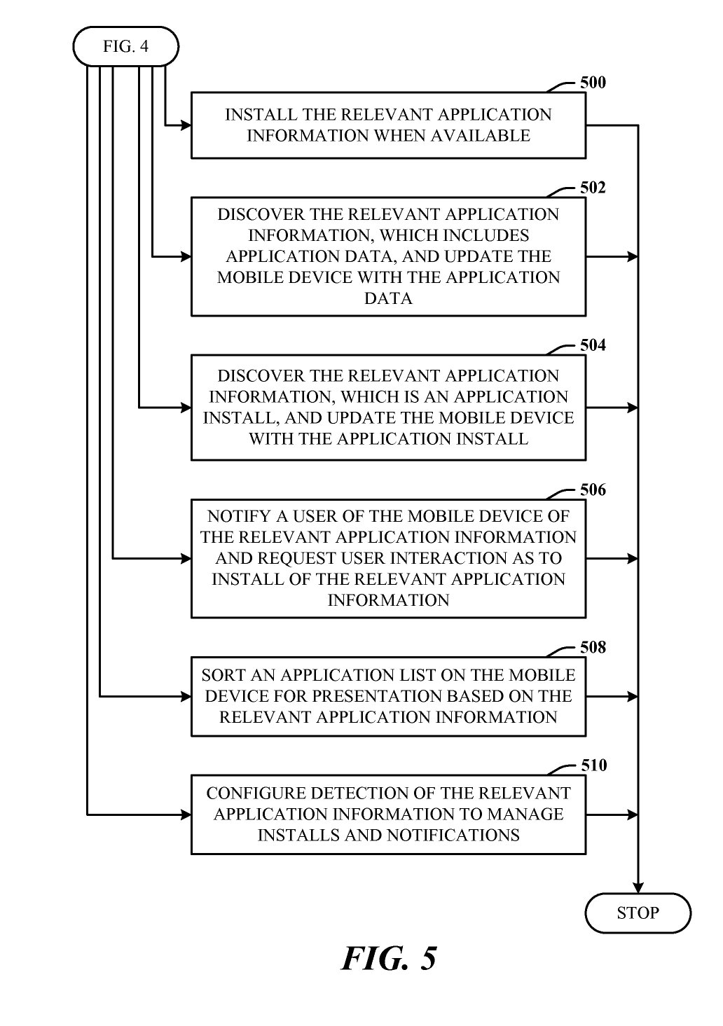

FIG. 5 illustrates further aspects of the method of FIG. 4. Note that the flow indicates that each block can represent a step that can be included, separately or in combination with other blocks, as additional aspects of the method represented by the flow chart of FIG. 4. At 500, the relevant application information is installed when available. At 502, the relevant application information, which includes application data, is discovered and the mobile device is updated with the application data. At 504, the relevant application information, which is an application install, is discovered, and the mobile device is updated with the application install. At 506, a user of the mobile device is notified of the relevant application information and user interaction as to install of the relevant application information is requested. At 508, an application list on the mobile device is sorted for presentation based on the relevant application information. At 510, detection of the relevant application information is configured to manage installs and notifications.

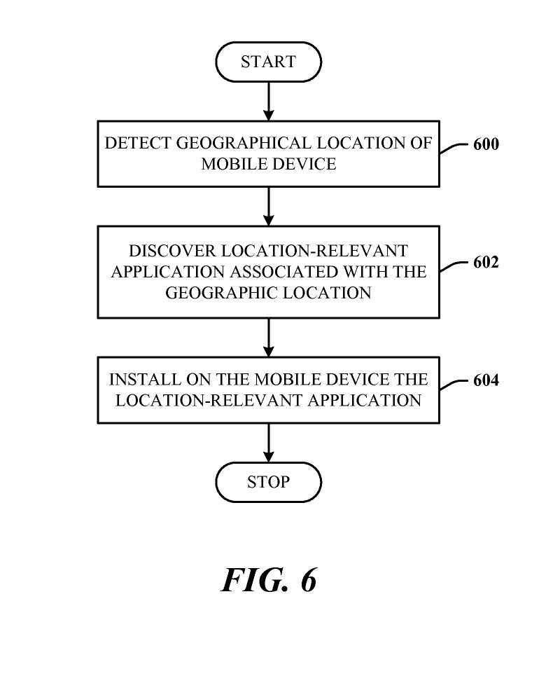

FIG. 6 illustrates an alternative method suitable for execution on a mobile device in accordance with the disclosed architecture. At 600, geographic location of the mobile device is detected. At 602, a location-relevant application associated with the geographic location is discovered. At 604, the location-relevant application is installed on the mobile device.

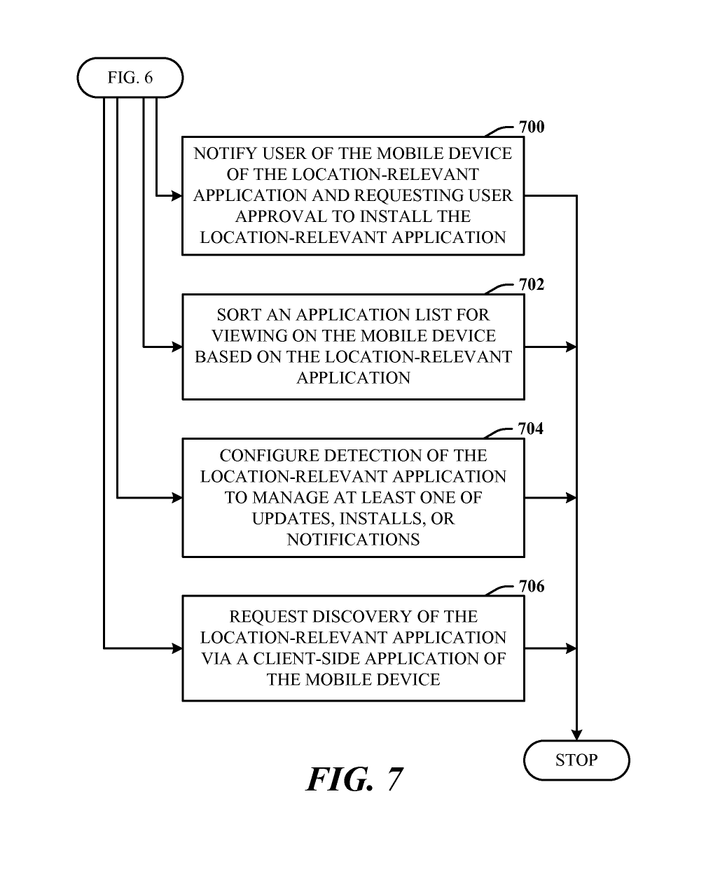

FIG. 7 illustrates further aspects of the method of FIG. 6. Note that the flow indicates that each block can represent a step that can be included, separately or in combination with other blocks, as additional aspects of the method represented by the flow chart of FIG. 6. At 700, a user of the mobile device is notified of the location-relevant application and requesting user approval to install the location-relevant application. At 702, an application list is sorted for viewing on the mobile device based on the location-relevant application. At 704, detection of the location-relevant application is configured to manage at least one of updates, installs, or notifications. At 706, discovery of the location-relevant application is requested via a client-side application of the mobile device.

As used in this application, the terms “component” and “system” are intended to refer to a computer-related entity, either hardware, a combination of software and tangible hardware, software, or software in execution. For example, a component can be, but is not limited to, tangible components such as a processor, chip memory, mass storage devices (e.g., optical drives, solid state drives, and/or magnetic storage media drives), and computers, and software components such as a process running on a processor, an object, an executable, a data structure (stored in volatile or non-volatile storage media), a module, a thread of execution, and/or a program. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

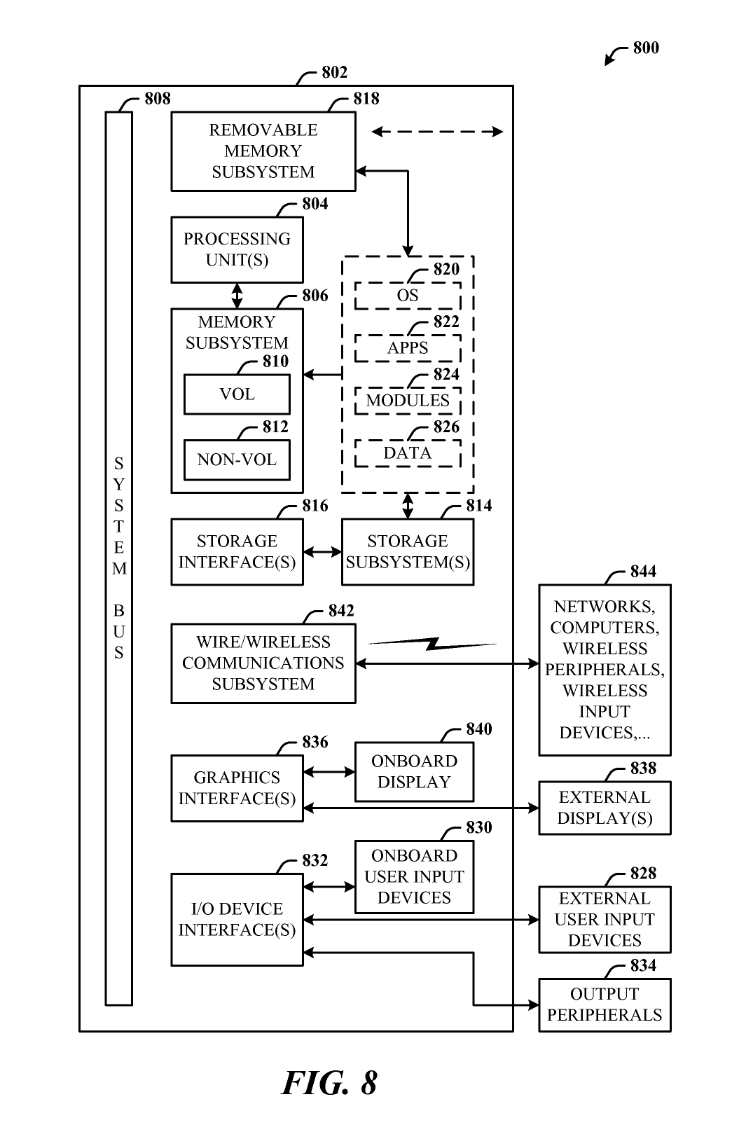

Referring now to FIG. 8, there is illustrated a block diagram of a computing system 800 that executes relevant information promotion in accordance with the disclosed architecture. However, it is appreciated that the some or all aspects of the disclosed methods and/or systems can be implemented as a system-on-a-chip, where analog, digital, mixed signals, and other functions are fabricated on a single chip substrate. In order to provide additional context for various aspects thereof, FIG. 8 and the following description are intended to provide a brief, general description of the suitable computing system 800 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 800 for implementing various aspects includes the computer 802 having processing unit(s) 804, a computer-readable storage such as a system memory 806, and a system bus 808. The processing unit(s) 804 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 806 can include computer-readable storage (physical storage media) such as a volatile (VOL) memory 810 (e.g., random access memory (RAM)) and non-volatile memory (NON-VOL) 812 (e.g., ROM, EPROM, EEPROM, etc.). A basic input/output system (BIOS) can be stored in the non-volatile memory 812, and includes the basic routines that facilitate the communication of data and signals between components within the computer 802, such as during startup. The volatile memory 810 can also include a high-speed RAM such as static RAM for caching data.

The system bus 808 provides an interface for system components including, but not limited to, the system memory 806 to the processing unit(s) 804. The system bus 808 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 802 further includes machine readable storage subsystem(s) 814 and storage interface(s) 816 for interfacing the storage subsystem(s) 814 to the system bus 808 and other desired computer components. The storage subsystem(s) 814 (physical storage media) can include one or more of a hard disk drive (HDD), a magnetic floppy disk drive (FDD), and/or optical disk storage drive (e.g., a CD-ROM drive DVD drive), for example. The storage interface(s) 816 can include interface technologies such as EIDE, ATA, SATA, and IEEE 1394, for example.

One or more programs and data can be stored in the memory subsystem 806, a machine readable and removable memory subsystem 818 (e.g., flash drive form factor technology), and/or the storage subsystem(s) 814 (e.g., optical, magnetic, solid state), including an operating system 820, one or more application programs 822, other program modules 824, and program data 826.

The operating system 820, one or more application programs 822, other program modules 824, and/or program data 826 can include entities and components of the system 100 of FIG. 1, entities and components of the system 200 of FIG. 2, entities and components of the system 300 of FIG. 3, and the methods represented by the flowcharts of FIGS. 4-7, for example.

Note that although described in the context of a computer, the disclosed architecture is equally applicable to mobile devices have similar computing capabilities individually, or as provided in combination with cloud computing.

Generally, programs include routines, methods, data structures, other software components, etc., that perform particular tasks or implement particular abstract data types. All or portions of the operating system 820, applications 822, modules 824, and/or data 826 can also be cached in memory such as the volatile memory 810, for example. It is to be appreciated that the disclosed architecture can be implemented with various commercially available operating systems or combinations of operating systems (e.g., as virtual machines).

The storage subsystem(s) 814 and memory subsystems (806 and 818) serve as computer readable media for volatile and non-volatile storage of data, data structures, computer-executable instructions, and so forth. Such instructions, when executed by a computer or other machine, can cause the computer or other machine to perform one or more acts of a method. The instructions to perform the acts can be stored on one medium, or could be stored across multiple media, so that the instructions appear collectively on the one or more computer-readable storage media, regardless of whether all of the instructions are on the same media.

Computer readable media can be any available media that can be accessed by the computer 802 and includes volatile and non-volatile internal and/or external media that is removable or non-removable. For the computer 802, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 802, programs, and data using external user input devices 828 such as a keyboard and a mouse. Other external user input devices 828 can include a microphone, an IR (infrared) remote control, a joystick, a game pad, camera recognition systems, a stylus pen, touch screen, gesture systems (e.g., eye movement, head movement, etc.), and/or the like. The user can interact with the computer 802, programs, and data using onboard user input devices 830 such a touchpad, microphone, keyboard, etc., where the computer 802 is a portable computer, for example. These and other input devices are connected to the processing unit(s) 804 through input/output (I/O) device interface(s) 832 via the system bus 808, but can be connected by other interfaces such as a parallel port, IEEE 1394 serial port, a game port, a USB port, an IR interface, short-range wireless (e.g., Bluetooth) and other personal area network (PAN) technologies, etc. The I/O device interface(s) 832 also facilitate the use of output peripherals 834 such as printers, audio devices, camera devices, and so on, such as a sound card and/or onboard audio processing capability.

One or more graphics interface(s) 836 (also commonly referred to as a graphics processing unit (GPU)) provide graphics and video signals between the computer 802 and external display(s) 838 (e.g., LCD, plasma) and/or onboard displays 840 (e.g., for portable computer). The graphics interface(s) 836 can also be manufactured as part of the computer system board.

The computer 802 can operate in a networked environment (e.g., IP-based) using logical connections via a wired/wireless communications subsystem 842 to one or more networks and/or other computers. The other computers can include workstations, servers, routers, personal computers, microprocessor-based entertainment appliances, peer devices or other common network nodes, and typically include many or all of the elements described relative to the computer 802. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 802 connects to the network via a wired/wireless communication subsystem 842 (e.g., a network interface adapter, onboard transceiver subsystem, etc.) to communicate with wired/wireless networks, wired/wireless printers, wired/wireless input devices 844, and so on. The computer 802 can include a modem or other means for establishing communications over the network. In a networked environment, programs and data relative to the computer 802 can be stored in the remote memory/storage device, as is associated with a distributed system. It will be appreciated that the network connections shown are exemplary and other means of establishing a communications link between the computers can be used.

The computer 802 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi™ (used to certify the interoperability of wireless computer networking devices) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system suitable for execution on a mobile device, comprising:
a detection component that detects geographic location of a mobile device and checks for a location-relevant application in response to detection of the geographic location; and
a processor that executes computer-executable instructions associated with the detection component.

2. The system of claim 1, wherein the detection component further checks for application data related to the geographic location.

3. The system of claim 1, wherein the detection component automatically installs location-relevant application.

4. The system of claim 1, wherein the location-relevant application is mapped to the geographic location and accessed when the mobile device reaches the geographic location.

5. The system of claim 1, further comprising a location-based provider that registers services and interfaces to the detection component to provide the location-relevant application.

6. The system of claim 5, wherein the location-based provider processes client requests for the location-relevant application.

7. The system of claim 1, further comprising a management component that enables user management of notifications, data, and application installs via the detection component.

8. The system of claim 7, wherein the management component adjusts presentation an application list based on the geographic location.

9. A method suitable for execution on a mobile device, comprising acts of:
detecting geographic location of the mobile device;
checking for relevant application information compatible with the mobile device in response to the geographic location; and
utilizing a processor that executes instructions stored in memory to perform at least one of the acts of detecting or checking.

10. The method of claim 9, further comprising installing the relevant application information when available.

11. The method of claim 9, further comprising discovering the relevant application information, which includes application data, and updating the mobile device with the application data.

12. The method of claim 9, further comprising discovering the relevant application information, which is an application install, and updating the mobile device with the application install.

13. The method of claim 9, further comprising notifying a user of the mobile device of the relevant application information and requesting user interaction as to install of the relevant application information.

14. The method of claim 9, further comprising sorting an application list on the mobile device for presentation based on the relevant application information.

15. The method of claim 9, further comprising configuring detection of the relevant application information to manage installs and notifications.

16. A method suitable for execution on a mobile device, comprising acts of:
detecting geographic location of the mobile device;
discovering a location-relevant application associated with the geographic location;
installing on the mobile device the location-relevant application; and
utilizing a processor that executes instructions stored in memory to perform at least one of the acts of detecting, discovering, or installing.

17. The method of claim 16, further comprising notifying a user of the mobile device of the location-relevant application and requesting user approval to install the location-relevant application.

18. The method of claim 16, further comprising sorting an application list for viewing on the mobile device based on the location-relevant application.

19. The method of claim 16, further comprising configuring detection of the location-relevant application to manage at least one of updates, installs, or notifications.

20. The method of claim 16, further comprising requesting discovery of the location-relevant application via a client-side application of the mobile device.
